(19) United States
(12) Patent Application Publication
(10) Pub. No.: US 2026/0072883 A1
(43) Pub. Date: Mar. 12, 2026

(54) LAYOUT DETECTION BASED ON INDIVIDUAL DOCUMENT COMPRESSION WITH COMPRESSION DICTIONARIES

(71) Applicant: SAP SE, Walldorf (DE)

(72) Inventors: Manuel Zeise, Karlsruhe (DE); Stefan Klaus Baur, Heidelberg (DE)

(21) Appl. No.: 18/829,630

(22) Filed: Sep. 10, 2024

(51) Int. Cl. G06F 16/21; G06F 16/93; G06F 40/103

(52) U.S. Cl. CPC G06F 16/212; G06F 16/93; G06F 40/103

(57) ABSTRACT

The disclosure generally describes methods, software, and systems for assigning incoming documents to a pre-defined layout class. A digitalized document corresponding to an original document is obtained. The digitalized document can be compressed, using a compression algorithm and a plurality of compression dictionaries, to generate a plurality of compressed documents. A respective compression ratio for each compressed document can be generated. A matching compression ratio associated with a first compressed document can be identified. The matching compression ratio can be identified as matching a selection criterion to identify a document layout matching the digitalized document. A first document layout associated with the compression dictionary used to generate the first compressed document can be assigned to the digitalized document. The assigned layout can be used to extract one or more data entries from the digitalized document to generate a record.

### TECHNICAL FIELD

The present disclosure relates computer-implemented methods, software, and systems for data processing and document layout detection.

### BACKGROUND

Computer systems or applications can process input documents that are generated in different layouts to extract data and use the data in the context of executing operations at the computer systems or applications, or to provide the data to other external entities. However, since the input documents can have different layouts, the extraction may not be unified, which can lead to complexity in the extraction processes and errors in identifying the right data to be extracted. For example, when data is extracted, it can be reviewed to determine if the extraction was accurate. In some cases, information, such as feedback received to correct errors in the data extraction, can be used to improve subsequent extraction processes.

### SUMMARY

Implementations of the present disclosure are directed to techniques and tools for assigning incoming documents to a pre-defined layout class (or type). More particularly, implementations of the present disclosure are directed to document layout detection for document data extraction.

In some implementations, a method includes: obtaining a digitalized document corresponding to an original document; compressing, by using a compression algorithm and a plurality of compression dictionaries, the digitalized document to generate a plurality of compressed documents, each of the plurality of compressed documents being generated based on a compression dictionary of the plurality of compression dictionaries, wherein each of the plurality of compression dictionaries is associated with a respective document layout of a plurality of document layouts; generating, for each of the plurality of compressed documents, a respective compression ratio to provide a plurality of compression ratios for the plurality of compressed documents; identifying, from the plurality of compression ratios, a matching compression ratio associated with a first compressed document, the matching compression ratio matching a selection criterion to identify a document layout matching the digitalized document; assigning a first document layout to the digitalized document, wherein the first document layout corresponds to the first compressed document generated based on the respective compression dictionary from the plurality of compression dictionaries; and extracting, using the assigned first document layout, one or more data entries from the digitalized document to generate a record to be stored at an entity for use in triggering a process at the entity.

The foregoing and other implementations can each optionally include one or more of the following features, alone or in combination. In particular, implementations can include all of the following features:

In some instances, the method can include generating a structured document based on performing data extraction from the digitalized document according to the assigned first document layout. In some instances, compressing the digitalized document includes applying the compression algorithm to a portion of the digitalized document to generate the plurality of compressed documents. The portion of the digitalized document is predefined to include either a number of pages of the digitalized document or a number of words of the digitalized document. In some instances, wherein the respective compression ratio is determined as a fraction of a size of the original document relative to an output size of an output stream resulting from compressing using each of the plurality of compression dictionaries.

In some instances, the matching compression ratio can be indicative of the first compressed document being with the lowest output size after compressing compared to output size after compression (with the respective different compression dictionaries) of the other compressed documents from the plurality of compressed documents. In some instances, each compression dictionary of the plurality of compression dictionaries is generated from a respective set of example documents including a respective document layout. The respective set of example documents can be used for training a layout identification model to learn characteristics of the plurality of document layouts. In some instances, the method can include an execution of the layout identification model for a set of documents based on assigning a document layout to each document of the set of documents, and a determination of a layout matching accuracy of the layout identification model. In response to determining that the layout matching accuracy is below a set accuracy threshold, at least one additional reference layout can be determined. At least one additional compression dictionary for the at least one additional reference layouts can be generated and added to the plurality of compression dictionaries to form an updated plurality of compression dictionaries. The updated plurality of compression dictionaries can be stored for use in compressing digitalized documents to determine a respective document layout based on executing the layout identification model, wherein the respective document layout is determined as a document layout from i) the plurality of document layouts or ii) the at least one additional reference layouts.

Other implementations of the aspect include corresponding systems, apparatus, and computer programs, configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described implementation provides an efficient layout identification. The system streamlines the document data extraction process by categorizing the layout using compression ratios, enabling efficient exploration and evaluation of the data layouts without an overwhelming complexity. The described implementation provides an enhanced system productivity. By automating the sequence of layout identification and document data extraction, the system enhances productivity, saving valuable time and effort in processing large volumes of documents with several types of layouts, which minimizes usage of system resources and eliminates the storage of complete documents for extended time intervals.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for data extraction based on layout identification, according to some implementations of the present disclosure.

FIG. 2 is a block diagram of an example data extraction system architecture, according to some implementations of the present disclosure.

FIG. 3 is a block diagram of an example text conversion process during a compression process of a document to identify a document layout in accordance with some implementations of the present disclosure.

FIG. 4A is a flowchart of an example process for data extraction based on layout identification, according to some implementations of the present disclosure.

FIG. 4B is a flowchart of another example process for data extraction based on layout identification, according to some implementations of the present disclosure.

FIG. 5 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to assigning a respective layout (layout class or type) to obtained documents. More particularly, implementations of the present disclosure are directed to document layout detection for document data extraction. In some implementations, document information extraction processes can be provided as a web-based service(s) to extract entities from provided documents (e.g., invoices, order requests, order confirmations). In some instances, the documents can be provided through other applications, services, or directly through users, and can be related to executed transactions, orders, or processes, among other examples. For example, a document can include structural elements that can include header information such as document date, sender name, sender account information, sender identifier, as well as body information, that can include information in tables or images. The tables can include line items with fields such as line-item text, a line-item quantity, and/or a line-item amount. For example, the table data can include numeral values related to items transferred between the parties (e.g., number of items sold or shipped). In some instances, an initial document can be processed with an optical character recognition (OCR) application or service to yield the text on the document with two-dimensional spatial information (i.e., the location of the extracted text on the document).

In some implementations, the extraction can be challenging when dealing with documents having various layouts. Thus, identifying the layout of a document to be processed can improve the accuracy of the data extraction. In accordance with implementations of the present disclosure, a document can be obtained and processed to extract some or all data for entities presented on the document based on the assigned document layout that is determined to match the document. The layout of a document can be determined by employing compression techniques to identify a layout of a set of predefined layouts that best matches the documents. The process can include compression of the text of the document with pre-defined compression dictionaries (relevant for the different pre-defined document layouts) to determine a document layout that best matches with characteristics of the pre-defined document layouts. The pre-defined compression dictionaries are unique to the document layout and can be used as a reference to determine which one best matches the layout of a given document that is processed.

In some implementations, the assignment of a document layout to a processed document can be used in the data extraction process, e.g., to improve the accuracy in the data extraction or to reduce resource expenditures for the document extraction process. In some instances, the assigned document layout can be used when performing fine-tuning or improvement of the data extraction process based on obtained feedback information for identified extraction errors from documents. In some instances, the feedback information can include information for correcting extraction errors and can be input into to a post-processing method that uses feedback data relevant for a document layout matching a document that is processed.

Available data extraction protocols can support a geometric comparison of a layout of a given document with other reference layouts by iterating over the reference layouts to determine a geometric overlap of boxes (e.g., formed around words, phrases, images, etc.) for the document's layout and the reference layout. The geometric comparison can involve a substantial number of calculations that can be more computationally expensive compared to using the compression techniques of the present disclosure. In some examples, neural networks can be used to calculate a numeric representation (embedding) of the document to then calculate a similarity score. For example, the similarity score can be calculated as a cosine similarity of the document's embedding and an embedding of the reference document(s). However, even with pre-calculated embeddings, the processing of a particular document can be costly as the calculation of the numeric representation may require resources (e.g., a GPU or a sizeable computation time on a CPU) above a defined resource threshold allocated or acceptable for the processing.

In some implementations, to address limitations of available data extraction protocols, a document data extraction method based on a layout identification as described in the present disclosure can be provided to support a more computationally efficient and fast, yet accurate extraction process. Based on implementation of the present application, example documents of various layout classes do not have to be stored and used when processing documents to extract data. Rather, a layout database storing compression dictionaries generated per layout class of a set of predefined layout classes can be stored and maintained as a reference to determine a layout to be assigned to an incoming document. Further, the current approach minimizes data extraction errors (e.g., confusion of the type of a field and data to be extracted) by supporting a selection of a most similar layout even in case where no identical layout is available. The implementations of the present disclosure can be used even if documents are of a given layout are provided in a different natural language. For example, if two invoices are incoming for processing and one of the invoices is in English and the other one is in German, for as long as the document types are associated with a similar document layout agnostic to the natural language, the method can be applied without requirements for additional adjustments. In some implementations, the identification of a layout for a given document can be performed by processing only a portion of the document, e.g., a few pages or few words of the document, to compress those portions based on different compression dictionaries and to use the computed compression ratios for that portion of the document to identify and assign the document layout class.

In some implementations, extraction of data from provided documents can be performed as part of a standalone application or service, or as an embedded service in the context of a system that implements processing logic for the extracted data. In some instances, the data extraction can be based on rule-based extraction heuristics, neutral network-based extractions models, large language models (LLMs) or other processing logic. In some instances, the extracted data can be merged and persisted so that it can be retrieved later by a user or an embedding system. For example, a travel and expense management system can obtain scanned business documents (e.g., uploaded by users) and can process the documents and convert the data into database entities. Such database entities can trigger process execution such as payment execution for incoming invoices or creation of a sales order.

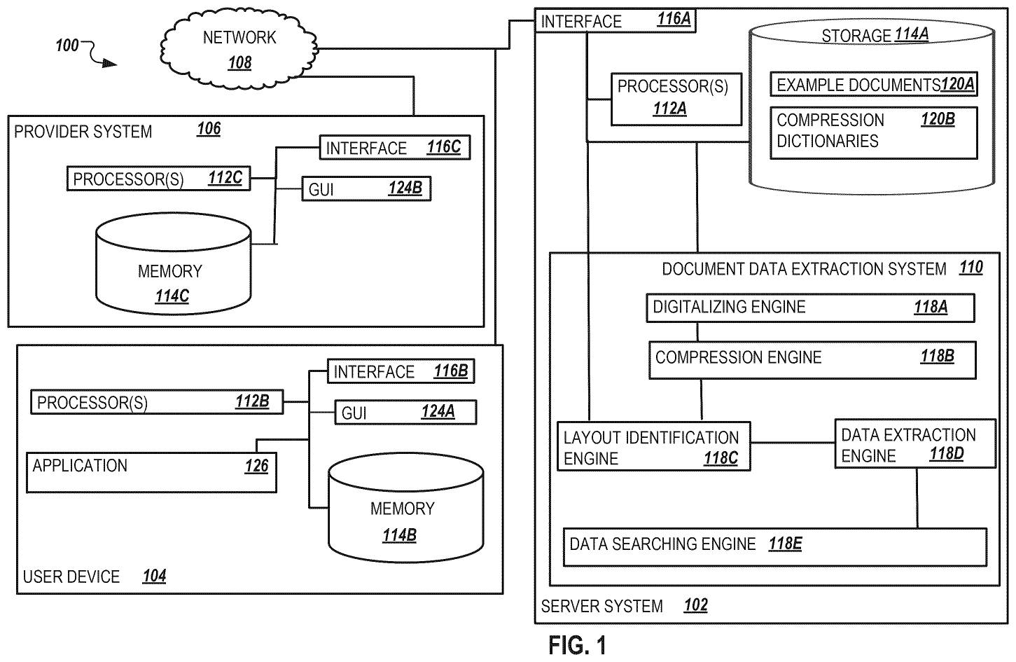

FIG. 1 is a block diagram of an example system 100 for data extraction based on layout identification, according to some implementations of the present disclosure. Specifically, the illustrated example system 100 includes or is communicably coupled with a server system 102, a user device 104, a Provider system 106, and a network 108. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 represents various forms of servers including, but not limited to a web server, an application server, a proxy server, a network server, and/or a server pool. In general, server system 102 can accept requests for application services and provides such services to any number of user devices 104 (e.g., the client device 104 over the network 108). In accordance with implementations of the present disclosure, and as noted above, the server system 102 can host a solution environment that can be a cloud environment providing software applications, systems, and services that can be consumed as a service. In some instances, the server system 102 can support configuring of various tenants of different types, as well as services of different types that are integrated in integration scenarios and support execution of defined processes. In some instances, the server system 102 includes a document data extraction system 110, a processor 112A, a storage 114A, and an interface 116A.

The document data extraction system 110 can be implemented to provide services (e.g., web-based services) to extract entities from documents (e.g., scanned documents, user provided documents, other documents). For example, the documents can be business or transactional documents, such as invoices, purchase orders, order confirmations, payment advice, etc. The extracted entities from the documents can be processes and converted into database entities that can be stored and/or used as a trigger for other processes configured at other entities, such as communicatively coupled applications.

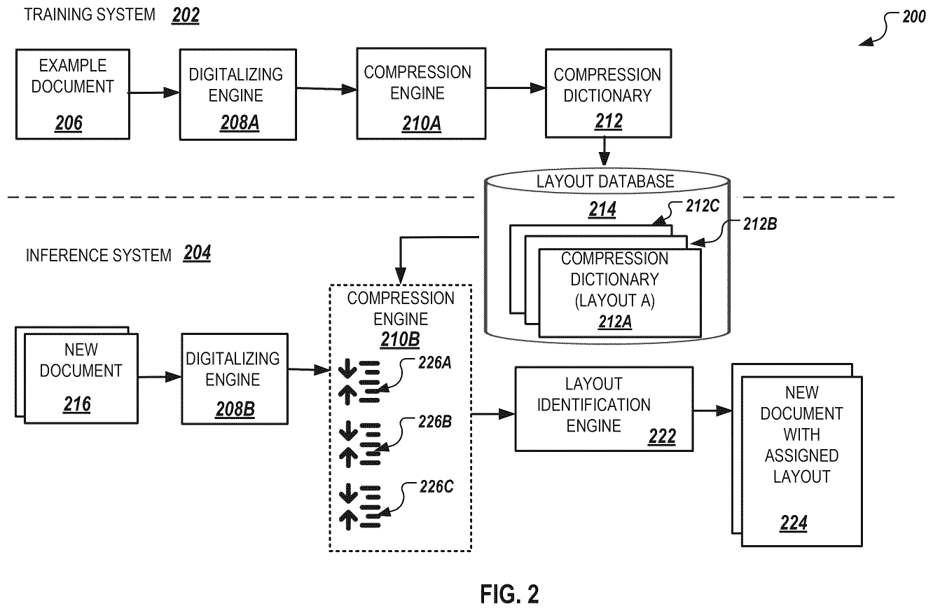

The document data extraction system 110 can include a digitalizing engine 118A, a compression engine 118B, a layout identification engine 118C, a data extraction engine 118D, and a data searching engine 118E. As user devices 104 generate requests for searching data in one or more documents, the document data extraction system 110 can be used to digitalize, compress, and process the one or more documents, as described with reference to FIGS. 2, 3, 4A, and 4B. In some instances, the layout identification engine 118C can identify, based on evaluating compression ratios computed for a document and using a plurality of document dictionaries generated for documents having different layout class, a corresponding layout matching with the document. The data extraction engine 118D can generate a structured document according to the corresponding identified layout. The data searching engine 118E can execute a search to extract data from the structured documents, e.g., for example, based on a received search criterion provided through a request by a user device 104.

The storage 114A can include example documents 120A and compression dictionaries 120B. The example documents 120A can be stored temporarily, for example, as template documents corresponding to particular layouts. In some instances, the example documents 120A can be used for training the document data extraction system 110. In some implementations, the compression dictionaries 120B include multiple dictionaries associated with different document layouts. The compression dictionaries 120B can be generated to distill characteristics of a layout of a particular document. Documents of different types may have different layouts and thus have different characteristics specific to the document type.

In some instances, the compression dictionaries can be generated as described in relation to FIG. 2. Multiple compression dictionaries can be generated for multiple different layouts of documents of different type. In some instances, for the generation of a compression dictionary for a given layout, one or multiple example documents can be used, individually or in combination. In some instances, a first compression dictionary can be generated for a layout of documents of certain type (e.g., of type A such as a tax invoice). In those cases, to generate a first compression dictionary for documents of the type, a compression algorithm can be applied over a text stream from a first document (e.g., an example document of the example documents 120A that is of the certain type) to perform a loss-less compression and to replace repeated sequences of identical text with a shorted representation. For example, the shorted representation can be stored in a table (e.g., a look-up table) where the length of the shorter representation can be determined based on information theory (entropy) and probabilities. In some instances, the table can include frequently occurring patterns or sequences of alphanumeric values and images in the data. The first compression dictionary can be structured as a collection of binary data (e.g., binary large objects) stored as a single entity. The first compression dictionary can be stored once it is generated and can be re-used to compress a new text stream(s). For example, the first compression dictionary can be used to process a new text stream processed at the document data extraction system 110 to identify the document layout of the respective document.

In some implementations, the generated compression dictionaries 120B for various document layouts can be used by the document data extraction system 110 when processing a given document to identify a layout of the various document layouts that best match the layout of the given document by exploiting compression of text of the document. The compression engine 118B of the document data extraction system 110 can invoke one or more compression dictionaries form the compression dictionaries 120B and use those to compress a received document. In general, when the received document is compressed based on different compression dictionaries 120B, the output sizes of the compressed streams of the document based on the respective compression dictionaries can depend on the correspondence between the respective layout associated with the compression dictionary with the document layout. Thus, when the ratio between the size of the received document and the output size of the compressed stream based on a given compression dictionary is relatively high compared to the other ratios, it can be interpreted that the output size of the compressed stream is the smallest. In some instances, ratios for each of the compression dictionaries can be generated and used to determine which one of the layouts matches the layout of the received document.

In some implementations, the document data extraction system 110 can be configured to train the layout identification engine 118C, by using the compression dictionaries 120B, to generate structured documents from obtained initial documents based on identifying their matching layout in accordance with implementations of the present disclosure.

The user device 104 and the Provider system 106 can each be any computing device operable to connect to or communicate in the network(s) 108 using a wireline or wireless connection. In general, each of the user device 104 and the Provider system 106 includes an electronic computer device operable to receive, transmit, process, and store any appropriate data associated with the system 100 of FIG. 1. Each of the user device 104 and the Provider system 106 is generally intended to encompass any client computing device such as a laptop/notebook computer, wireless data port, smart phone, personal data assistant (PDA), tablet computing device, one or more processors within these devices, or any other suitable processing device. The user device 104 and the Provider system 106 respectively include interface(s) 116B and 116C, processor(s) 112B and 112C, memories 114B and 114C, and graphical user interface(s) (GUIs) 124A and 124B. The user device 104 can include one or more applications 126. In some implementations, the application 126 can use parameters, metadata, and/or provide application programming interfaces (APIs) to interact with other systems, and for example, to access the document data extraction system 110 at the server system 102. In some instances, an application 126 can be an agent or client-side version of the one or more enterprise applications running on an enterprise server (not shown).

In some implementations, any or all of the components of the example system 100, both hardware or software (or a combination of hardware and software), can interface with each other or the interface(s) 116A, 116B, and 116C (or a combination of both) over the network 108. In some instances, services provided by applications running on the user device 104 can be accessible by service consumers. For example, the application 126 can be executed to transmit requests to the document data extraction system 110 to request process of data associated with one or more documents at the document data extraction system 110, where extracted data from the one or more documents can be provided to the application 126. In some instances, upon receipts of extracted data as provided to the application 126 by the document data extraction system 110, the application 126 can be configured to initiate a process, for example, based on receiving the data or based on evaluating the data with reference to predefined process rules. For example, the application 126 can provide a scanned document of an invoice to the document data extraction system 110 to extract information about a vendor on the invoice and a final amount. In that example, in response to obtaining such extracted data from the document at the document data extraction system 110, the data can be processed according to rules or other logic defined for processing invoices. For example, based on the rule or logic, a process relevant to the identified vendor as identified from the extracted data can be trigger, where the process is specific to the final amount falling in a particular price range (e.g., invoices above 10,000 Euro and below 100,000 Euro can be process by a different process compared to those below 10,000 Euro or those above 100,000 Euro).

In some instances, the user device 104 and/or the Provider system 106 can include a computer that can be connected to an input device(s), such as a keypad, touch screen, or other device that can receive user interactions, and an output device(s), such as a display, that displays information (e.g., information associated with the operation of the server system 102, or the device 104, including digital data, visual information, or a GUI 124A and 124B, respectively). The GUIs 124A and 124B each interface with at least a portion of the system 100 for any suitable purpose, including generating a visual representation of the application 126. In particular, the GUIs 124A and 124B can each be used to view and navigate various web pages accesses through the user device 104 or the provider system 106. The GUIs 124A and 124B can each provide the user with an efficient and user-friendly presentation of business data provided by or communicated within the system 100. The GUIs 124A and 124B can each include multiple customizable frames or views having interactive fields, pull-down lists, and buttons operated by the user.

In some implementations, the network 108 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 108, is transferred using any number of network layer protocols, such as Internet Protocol (IP), Multiprotocol Label Switching (MPLS), Asynchronous Transfer Mode (ATM), Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 112A, 112B, 112C included in the user device 104 or the Provider system 106 can be a central processing unit (CPU), a graphics processing unit (GPU), a tensor processing unit (TPU), an application specific integrated circuit (ASIC), a field-programmable gate array (FPGA), or another suitable component. Each processor 112A, 112B, 112C included in the user device 104 or the Provider system 106 can execute instructions and process data to perform operations at the user device 104 or the Provider system 106, respectively. Specifically, each processor 112A, 112B, 112C included in the user device 104 or the Provider system 106, executes the functionality required to send requests to the server system 102 and to receive and process responses from the server system 102.

Interfaces 116A, 116B, 116C are used by the server system 102, the user device 104, and the Provider system 106, respectively, for communicating with other systems in a distributed environment-including within the system 100—connected to the network 108. In some implementations, the interfaces 116A, 116B, 116C each include logic encoded in software and/or hardware in a suitable combination and operable to communicate with the network 108. In some instances, the interfaces 116A, 116B, 116C can each include software supporting one or more communication protocols associated with communications such that the network 108 or interface's hardware is operable to communicate physical signals within and outside of the illustrated system 100.

The storage 114A, 114B, 114C can include any type of memory or database module and can take the form of volatile and/or non-volatile memory including, without limitation, magnetic media, optical media, random access memory (RAM), read-only memory (ROM), removable media, or any other suitable local or remote memory component. The storage 114A, 114B, 114C can store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 102, the user device 104, or the Provider system 106, respectively.

There can be any number of user devices 104 and Provider systems 106 associated with, or external to, the system 100. Additionally, there can also be one or more additional devices external to the illustrated portion of system 100 that are capable of interacting with the system 100 via the network(s) 108. Further, the term “client,” “client device,” and “user” can be used interchangeably as appropriate without departing from the scope of the disclosure. Moreover, while device can be described in terms of being used by a single user, the disclosure contemplates that many users can use one computer, or that one user can use multiple computers. As used in the present disclosure, the term “computer” is intended to encompass any suitable processing device. For example, although FIG. 1 illustrates a single server system 102, a single user device 104, a single Provider system 106, the system 100 can be implemented using a single, stand-alone computing device, two or more servers 102, or multiple devices. The server system 102, the user device 104 and the Provider system 106 can include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the user device 104 and the Provider system 106 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 can also include or be communicably coupled with an e-mail server, a Web server, a caching server, a streaming data server, and/or another suitable server.

Regardless of the particular implementation, “software” can include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Python, Visual Basic, assembler, Perl®, ABAP (Advanced Business Application Programming), ABAP OO (Object Oriented), any suitable version of 4GL, as well as others. While portions of the software illustrated in FIG. 1 are shown as individual modules that implement the various features and functionality through various objects, methods, or other processes, the software can instead include multiple sub-modules, third-party services, components, libraries, and such, as appropriate. Conversely, the features and functionality of various components can be combined into single components as appropriate.

In some implementations, the Provider systems 106 can expose multiple relevant APIs in advance, with each of the APIs being associate with a similar or different communication protocol and can support different functionalities and resource exposure. The user device 104 can include various API consumption tools, for example, API management tools, visual studio (VS) and OS (operating system) software development kits (SDKs), build tools, and web integrated development environment (WebIDE) tools. The communication between the user device 104 (as API consumers) and the Provider systems 110 can include several different communication protocols configured to optimize document data extraction and data search, as further described in detail with reference to FIGS. 2-5.

FIG. 2 illustrates a block diagram of an example data extraction system architecture 200, according to some implementations of the present disclosure. The example document data extraction system architecture 200 includes a training system 202 and an inference system 204.

The training system 202 includes an example document(s) 206, a digitalizing engine 208A, a compression engine 210A, compression dictionaries 212A, 212B, and 212C, and a layout database 214. In some implementations, the training system 202 can be used to execute a training process, where at training time, one or more example documents 206 that are of a particular layout can be received and processed to generate a particular compression dictionary for that layout. For example, the example document 206 can be a document having a layout of type A (e.g., corresponding to an invoice document type, a purchase order type, other). In some instances, one or multiple training processes can be performed per document layout to generate multiple compression dictionaries. The processing of the example document at the training system 202 can be performed without requiring that the example document is annotated with their layout class, and the training execution can be independent of the document type. As such, the training system 202 can process different example documents and generate multiple compression dictionaries per document layout class. The resulting compression dictionaries 212A, 212B, and 212C can be stored together with metadata in the layout database 214.

In some implementations, after generation of the compression dictionaries 212A, 212B, and 212C, the example documents used during the training process can be deleted if they were stored at the training system 202. In some instances, the generation of the layout database 214 can be with reference to relevant document layouts for one or multiple systems. For example, the layout database 214 can be invoked from multiple system to request compressions dictionaries to be used at inference time when processing a document. In some instances, the layout database 214 can be updated to include further compression dictionaries or to have a compression dictionary modified based on received input from executed layout identification processes with reference to the layout database 214.

The inference system 204 includes a new document 216, a digitalizing engine 208B, a compression engine 210B, a layout identification engine 222, and new structured documents 224. The new document 216 includes a document without an assigned layout, and during inference phase, the layout for the new document 216 can be identified and assigned to the new document 216. The assigning of the layout to the new document 216 can be used for performing data extraction from the new document 216, for fine-tuning the data extraction process based on feedback data from previous extraction processes for the same type of a layout, or as part of post-processing for a data extraction process to automatically review the extraction based on the understanding what the document layout is.

In some instances, the example document 206 and the new document 216 can be received as documents in searchable format that does not need to be further OCRed. In some other instances, the example document 206 and the new document 216 as received can include data in a format that is not directly searchable by text-based search engines. For example, the example document 206 and the new document 216 can include images or scanned documents (e.g., pdf, png, jpeg, tiff), at least a portion of the document including text in unsearchable format. In some instances, the digitalizing engine 208A, 208B can be configured to process the example document 206 or the new document 216 to generate a digitalized document including data representations in a semantically searchable format. In some instances, the digitalizing engine 208A, 208B can process the example document 206 or the new document 216 to remove noise, to correct skew, to enhance contrast, to apply text recognition to match the shapes identified within the example document 206 and the new document 216 to corresponding characters and image identifiers (logos) stored in the database 214. The digitalizing engine 208A, 208B can output a text representation of each page of the documents 206, 216 where the original layout of the text elements is approximated using white space.

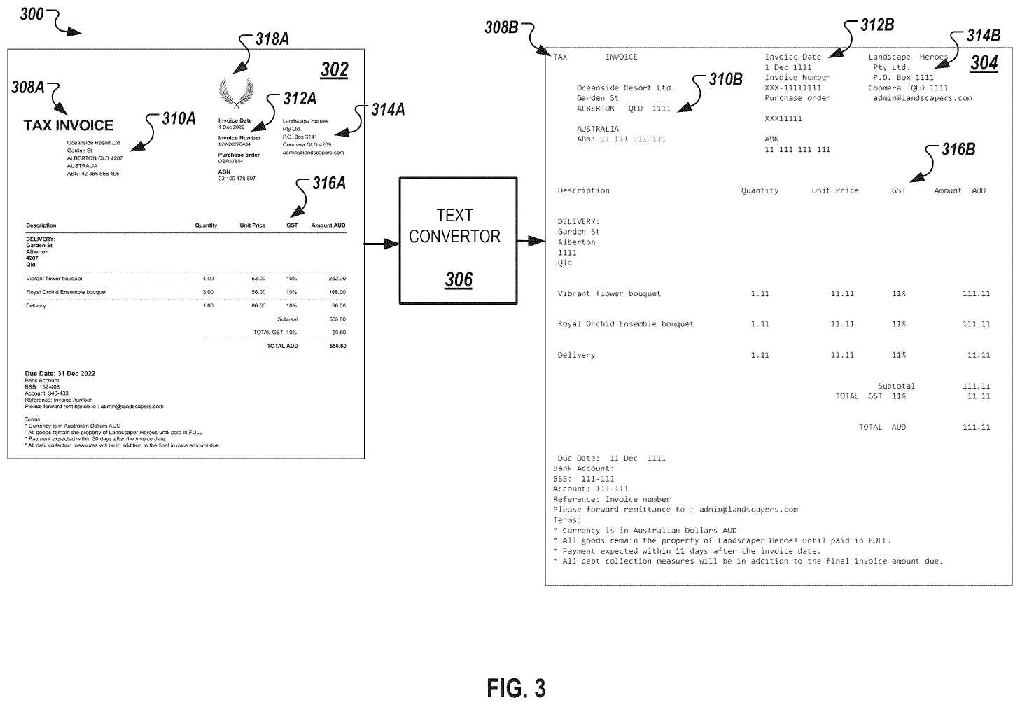

In some instances, during training phase at the training system 202 and inference phase at the inference system 204, the digitalizing engines 208A and 208B can perform a post-processing step to the text recognized of the respective document (i.e., the example document 206 or the new document 216), to transform all alpha-numeric values (e.g., telephone numbers, tax IDs, or reference numbers) to a unitary value to reduce the impact of actual numbers during the compression steps. For example, all digits of the example document 206 can be replaced with ‘1’s and all letters in alpha-numeric strings can be replaced with a preset letter (e.g., ‘X’), as described with reference to FIG. 3.

In some implementations, the compression engine 210A, 210B can compress digitalized documents to distill the characteristics of the input layout. For example, the compression engine 210A, 201B executes a compression algorithm that operates on a text stream and performs a loss-less compression. The compression algorithm can include any class of the compression algorithm that replaces repeated sequences of identical text with a shorter representation (look-up table) where the decision on the length of the shorter representation is based on information theory (entropy) and probabilities. For example, the compression can be based on run-length-encoding, Huffman coding, dictionary-based compression, Burrows-Wheeler transformation, Shannon coding, GZIP, BZIP2, Zstandard, or any combination of compression methods that compress text data by significantly reducing the document size.

In some implementations, at training phase at the training system 202, a set of digitalized example documents having a particular document layout can be compressed by the compression engine 210A by treating them together but as individual files. For example, a compression algorithm can be applied and a common compression dictionary can be built. Upon completion of the compression, the common compression dictionary can be extracted, and a compression ratio for each of the digitalized example documents as compressed based on the common compression dictionary can be stored. In some instances, the compressed output stream can be discarded to optimize data storage, and the compression dictionary can be stored at the layout database 214 together with metadata (e.g., including compression ratios for example documents, a layout name, an identifier (e.g., customer identifier), another layout identifier, etc.). The compression dictionaries 212A, 212B, 212C typically have a fraction of the size of the input document. In some instances, the size of the compression dictionaries 212A, 212B, 212C can be restricted if the compression is implemented based on a compression algorithm that supports size restriction.

Each of the compression dictionaries 212A, 212B, 212C includes a table of frequently occurring patterns or sequences of alphanumeric values and images, in the data associated with a particular document layout. In some instances, the compression dictionaries 212A, 212B, 212C can be structured as a collection of binary data (e.g., binary large objects) stored as a single entity.

During inference phase, the compression engine 210B can retrieve from the layout database 214 the compression dictionaries 212A, 212B, 212C. For example, the compression engine 210B can retrieve a set of the compression dictionaries stored at the layout database 214 that meet a criterion for use at the inference system 204. For example, the training system 202 can be used to generate compression dictionaries to be used by various systems including the inference system 204, where only a subset of the dictionaries may be viable for the identification of the layout in this context.

The compression engine 210B can compress the text of the digitalized new document with each of the respective compression dictionaries. During the compression, the compression dictionaries 212A, 212B, 212C are not updated based on the information of the incoming document. Thus, during inference the compression dictionaries are only used as a reference without modification. The resulting compressed output stream from each of the compression operations may not be stored, however, the compression engine 210B can use the sizes of the output streams to generate the corresponding compression ratios as a relative measurement of the original size to the output size compared.

In some implementations, the compression engine 210B can execute the compressions using the compression dictionaries 212A, 212B, 212C as parallel processes or in a sequence. In some instances, upon compressing the digitalized document based on a first compression dictionary of the compression dictionaries 212A, 212B, 212C, the compression ratios 226A, 226B, and 226C can be calculated and provided to the layout identification engine 222. The layout identification engine 222 can process the compression ratios 226A, 226B, 226C as generated based on the compression dictionaries 212A, 212B, 212C respective. The compression ratios can be calculated based on an output size for each of the pre-defined layouts'compression dictionaries 212A, 212B, 212C. For example, the output size for each of the pre-defined layouts'compression dictionaries 212A, 212B, 212C together with the original size of the input can be used to calculate the compression ratio (e.g., original input was 10 kB, output is 2 kB, then the compression ratio is 5). The layout identification engine 222 can select the layout with the best matching (e.g., highest in the example when the compression ratio is calculated as a ration between the original size and the compressed size) compression ratio. In some instances, the compression ratios as computed can be filtered to include only ratios that are above a pre-defined threshold and those of the ratios above the pre-defined ratio can be compared to identify the matching ratio for the document. Based on identifying the matching ratio, the incoming new documents 216 can be assigned to the pre-defined layout class corresponding to the compression dictionary that was used to generate the matching ratio. In some case, if no compression dictionary yields a compression ratio above the pre-defined threshold, no pre-defined layout is assigned to the new document. If the pre-defined threshold is zero, then all compression ratios are to be compared to determine the matching ratio. In some instances, a non-zero value threshold can be set to define an “unknown layout” category which can be used for some use cases, e.g., to define a high conformity rule for the layout identification. For example, the non-zero value can be set up so that upon processing of multiple new documents at the inference system 204, the new documents can be filtered to determine if there are documents that do not substantially match with any of the layouts corresponding to the used available compression dictionaries. Upon performing such filtering, those documents that are left out due to falling into the “unknown layout” can be evaluated to determine if they correspond to another document layout, that is not associated with a dictionary of the layout database 214. Based on such identification, a new training process can be configured at the training system 202 so that at least some of the filtered documents can be used as the example document 206 to generate a compression dictionary substantially similarly to the generation of the compression dictionary 212.

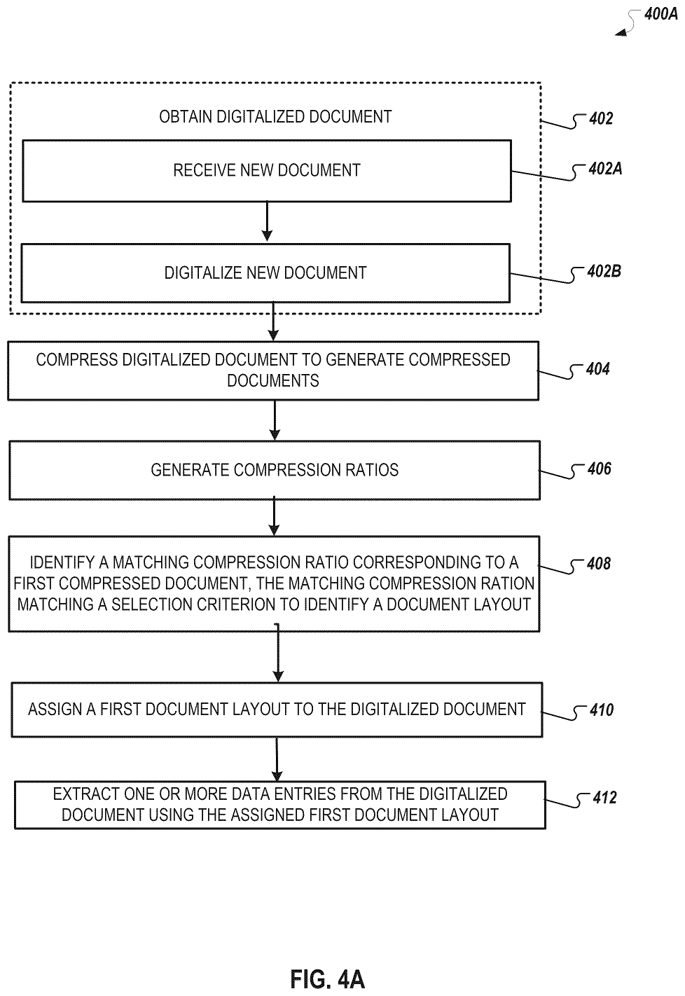

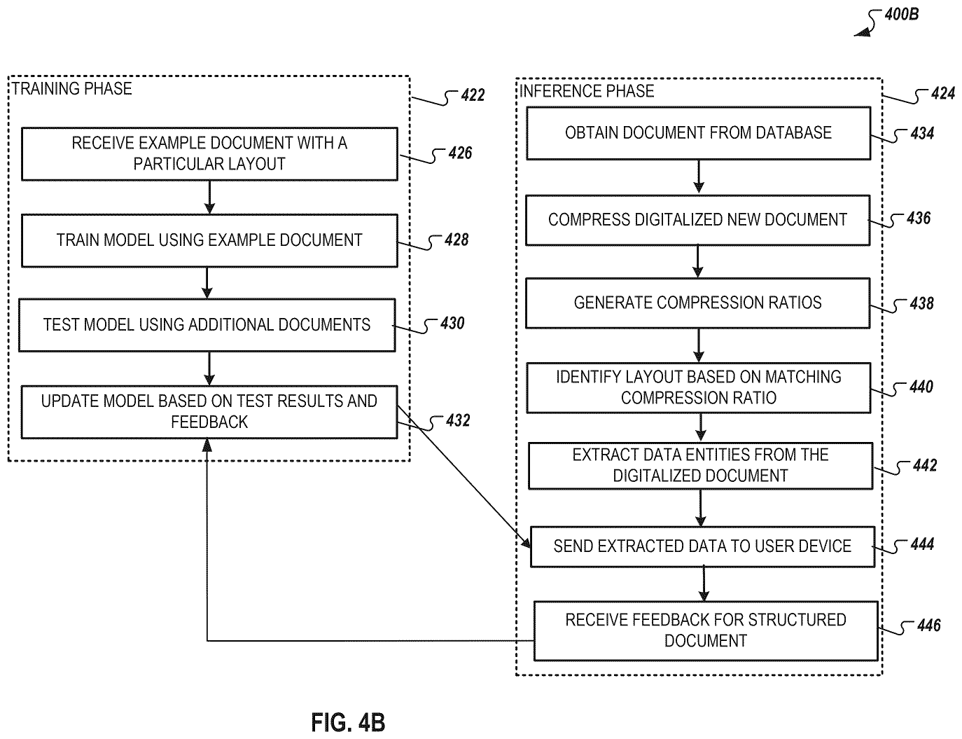

In some implementations, the calculated compression ratios 226A, 226B, and 226C can be evaluated based on a predefined evaluation rule to determine whether a compression ratio is to be discarded (e.g., below a threshold level as described in relation to FIG. 4), and/or whether the compression ratio meets a criterion to be identified as the matching ratio (e.g., above a threshold level defined for a set of document layouts relevant for the inference system 204). The compression engine 210B can execute the compressions applying one of the different possible operational modes, where a first operational mode can be configured for the inference system 204. The operational mode can define a portion of the document that is subject to the compression: compress the whole document, compress only a first n pages of the document, compress a predefined range of pages (e.g., only the first n pages and the last k pages, and leaving out middle pages), and compress only the first m words in the document, among other examples. In some instances, the compression engine 210B can iteratively perform the compressions based on multiple compression dictionaries and can be configured to perform an early stop of the execution of the compression process. For example, the process can be configured to stop based on generating a compression ratio that meets a criterion to stop the execution and select the document layout corresponding to the compression dictionary used to output a compressed stream associated with the generated ratio. In other examples, the process can be configured to stop, at a predefined set time to evaluate the compression ratios generated until that time point and determine whether the ratios are below a pre-defined compression ratio threshold to trigger an interruption of the layout identification process.

In some instances, the layout identification engine 222 can apply the identified layout to generate a new structured document 224 having the identified layout. The example document data extraction system architecture 200 ensures efficient digitalizing and compression according to multiple document layouts as stored at the layout database 214 and used at inference to identify a best match.

FIG. 3 is a block diagram of an example text conversion process 300 during a compression process of a document to identify a document layout in accordance with some implementations of the present disclosure. The example text conversion process 300 can include a document 302 and a new converted document 304 that can be generated by text converter 306, such as the digitalizing engine 118A of the document data extraction system 110 of FIG. 1, the digitalizing engines 208A and 208B of FIG. 2. The text converter 306 can be an OCR engine that can perform recognition over the document 302 and provide an output file that can be searched. The document 302 and the new structured document 304 include a header 308A, 308B, receiver data 310A, 310B, document identifying data 312A, 312B, sender data 314A, 314B, and itemized data 316A, 316B, respectively. The document 302 can include a visual identifier (e.g., logo) 318A of a sender of the document that can be processed by the text converter 306 to determine a sender (user) identifier. In some instances, extraction of data associated with the sender identifier can be used in the context of identifying a document layout and data extraction from the document as described in relation to FIGS. 1 and 2. For example, based on determining the sender identifier, it can used to determine predefined layouts associated with the sender identifier which can be retrieved from a layout database as described in relation to FIG. 2.

The example illustrated in FIG. 3 shows a digital replacement of the alphanumeric values at the document 302 with other example placeholder values to generate the new converted document 304. As shown, the digits can be replaced with ‘1’s and the letters in alpha-numeric strings can be replaced with ‘X’s, e.g., a purchase order reference ‘ORD12345’ becomes ‘XXX11111’ and the date ‘12/10/2024’ becomes ‘11/11/1111.’ In some implementations, the text converter 306 replaces digits and letters of particular portions of the document (e.g., document identifying data 312A, 312B, sender data 314A, 314B, and itemized data 316A, 316B) or throughout the document 304. As shown in FIG. 3, the text converter 306 preserves the document layout by structuring the identified and compressed data according to white spaces of the original document 302. In some implementations, one or more graphical elements such as logos or horizontal lines can be discarded.

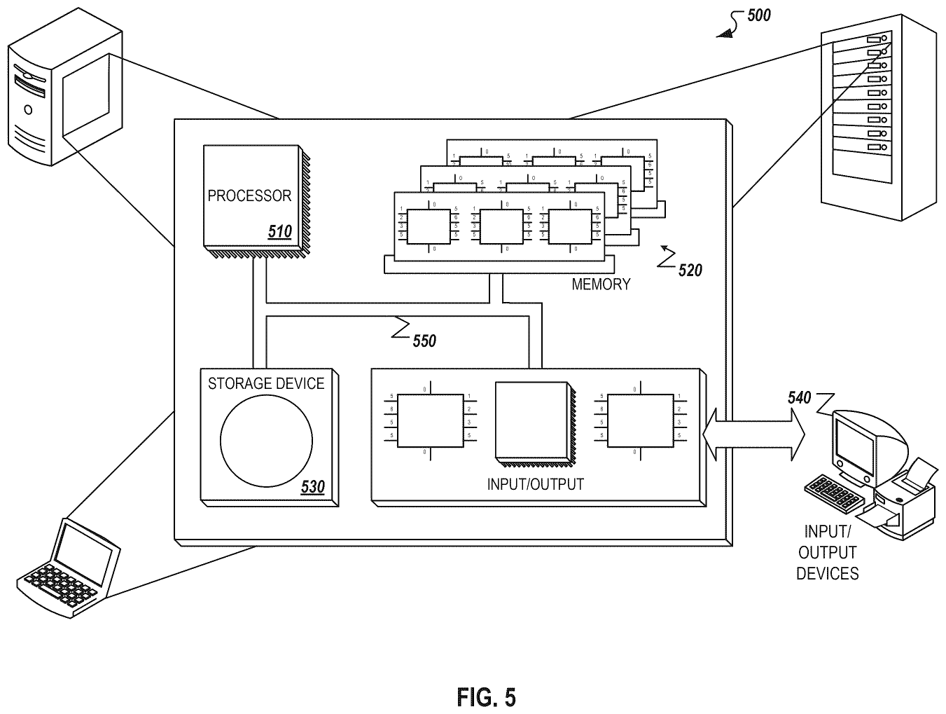

FIG. 4A is a flowchart of an example process 400A for data extraction based on layout identification, according to some implementations of the present disclosure. In some implementations, the example process 400A can be performed by the document data extraction system 110 of the example system 100, described with reference to FIG. 1, at the inference system 204 of the document data extraction system architecture 200, described with reference to FIG. 2, or the example computing system 500, described with reference to FIG. 5.

At 402, a digitalized document is obtained, by one or more processors (e.g., digitalizing engine 118A of document data extraction system 110 of FIG. 1, the digitalizing engine 208B of FIG. 2 and/or the text converter 306 described with reference to FIG. 3). In some instances, the digitalized document can be a file that is in a machine-readable text format. For example, the digitalized document can be an image of text representing an invoice document. In some cases, the invoice document can be processed to transform all alpha-numeric values (e.g., telephone numbers, tax IDs, or reference numbers) to a unitary value to reduce the impact of actual numbers during the compression steps, as described for example in relation to FIG. 3.

In some instances, the digitalized document can be obtained at 402 by processing a received new document (at 402A), and obtaining the digitalized document, at 402B, by digitalizing the new document (e.g., through a text conversion using an optical character recognition (OCR) process that converts the received new document into machine-readable text format or as shown in relation to FIG. 3). The new document (e.g., document 216 described with reference to FIG. 2 or document 302 described with reference to FIG. 3) can be received without an assigned layout. In some instances, the new document as received at 402A can be in a format that is not directly searchable by text-based search engines. In some instances, digitalizing the new document can be executed by a digitalizing engine (e.g., the digitalizing engine 208A, 208B described with reference to FIG. 2). Digitalizing the new document includes processing the new document to obtain the digitalized document, where the digitalized document can include data representations in a semantically searchable format.

In some instances, generating the digitalized document (e.g., as at 402B) can include processing the new document to perform one or more of: to remove noise, to correct skew, to enhance contrast, to apply text recognition to match shapes identified within the new document to corresponding characters and image identifiers (logos) stored in a reference database.

In some implementations, the new document that is received at 402A can be digitalized to generate a converted digitalized document that includes a text representation of pages of the documents (e.g., one, a set, or all of the pages). The generation of the text representation includes a generation of an approximation of the original layout of the text elements using white space between grouped portions of the document (e.g., header, sender data, document identifying data, receiver data, and itemized data).

In some instances, after obtaining the digitalized document (e.g., as generated at 402B or as obtained), a post-processing operation can be performed to transform numerical data such as amounts (e.g. unit prices) and/or alpha-numeric values (e.g., telephone numbers, tax IDs, or reference numbers) according to a replacement rule to reduce the impact of actual numbers during the compression steps. The transformation can be performed as described in relation to FIG. 3. All digits in the document can be replaced with ‘1’s and all letters in alpha-numeric strings are replaced with ‘X’s, e.g., a purchase order reference ‘ORD12345’ becomes ‘XXX11111’ and the date ‘12/10/2024’ becomes ‘11/11/1111’. Such transformation can maintain the layout structure of the document and can reduce the complexity and resources needed for executing compression, thus, can support a resource optimization for the process 400A.

At 404, the digitalized document is compressed, by the one or more processors, to generate compressed documents using respective compression dictionaries corresponding to different document layouts. Since the digitalized document does not have an assigned document layout, the digitalized document is compressed using compression dictionaries associated with different document layout in the process of identifying the layout class of the digitalized document as described.

In some instances, the compression process can include obtaining compression dictionaries, for example, corresponding to a sender identifier (determined from the text on the document as retrieved by a text recognition service or from metadata obtained with the document). The compression dictionaries can be obtained from a layout database substantially similar to the layout database 214 of FIG. 2. The compression process includes the application of a compression algorithm to the digitalized documents (as a text stream) with each of the compression dictionaries to perform a loss-less compression, to determine one or more characteristics of the corresponding layout based on evaluating the output streams from the compression. The compression algorithm can include a replacement of repeated sequences of identical text within the digitalized document with a shorter representation (look-up table) according to a respective compression dictionary used for the compression.

At 406, compression ratios are generated, by the one or more processors, to determine a layout matching the layout of the obtained digitalized document. A compression ratio is generated for each compressed document of the compressed documents. The compression ratio is generated for each of the pre-defined layouts as a fraction of the size of the input document relative to an output size of the compressed stream based on a given compression dictionary, showing how much the size of the document is reduced after the compression.

At 408, a compression ratio that meets a selection criterion is identified, by the one or more processors. In some instances, the compression ratios that are generated at 406 can be evaluated according to the selection criteria to determine the matching compression ratio that is the one generated based on a compression dictionary that yields a compression output stream that is the smallest compared to the output streams generated by compression with the other compression dictionaries. In some instances, the selected compression ratio is indicative of a layout with an optimal performance to reduce its size after compression with reference to a compression dictionary for the particular layout. The evaluation of the compression ratios can be performed with reference to a pre-defined threshold that can be assigned for the layout identification process, to the inference system where the identification is performed, or otherwise. In some implementations, the obtained digitalized document can be considered as not matching any of the pre-defined layouts from which can be selected. For example, if no compression dictionary yields a compression ratio above the pre-defined threshold, no pre-defined layout can be assigned to the new document without further evaluation. In some instances, the compression ratios generated for such a digitalized document can still be used to identify which document layout is the closest to the layout of the digitalized document, e.g., by identifying the best performing compression dictionary to reduce the output size of the compressed stream.

In some instances, the selection criterion can define a compression ratio threshold that can be used to filter out compression dictionaries (and their respective layouts) that do not provide a compression ratio above the defined threshold. Such definition of a compression ratio threshold can prioritize evaluation of compression ratios that are associated with higher standards for similarity between their respective layouts and the layout of the digitalized documents thus to minimize variability (in the case where the selection is from a large number of layouts) and improve performance of when executing the matching to identify the layout. In some instances, setting up compression ratio thresholds can support processing of compression ratios in batches in the context of evaluating documents to identify their layout when selecting from a large set of available layouts with corresponding compression dictionaries. In some implementations, the threshold can be set to zero to support evaluation of all calculated compression rations without pre-filtering.

At 410, a first document layout is assigned to the digitalized document. The first document layout corresponds to the first compressed document generated based on the respective compression dictionary from the plurality of compression dictionaries.

At 412, one or more data entries from the digitalized document are extracted, using the assigned first document layout, to generate a record to be stored at an entity for use in triggering a process at the entity.

In some instances, a structured document can be generated, by the one or more processors, using the assigned first document layout and the digitalized document. Generating the structured document can include data extraction from the digitalized document according to the document layout corresponding to the selected compression ratio. Data extraction from the digitalized document can include formatting the data for further data processing. In some instances, layout based data extraction from the digitalized document can include rule-based extraction heuristics, using neural network-based extraction models such as DocumentReader or Charmer, Large Language Models (LLM) or post-processing logic such as sender address harmonization and matching. In some instances, the layout based data extraction can be distributed to be executed by multiple data extraction components according to a message-based orchestration sequence. In some instances, the results obtained by the different data extraction components can be merged to form the structured document, which can be persisted in a database and provided a accessible for retrieval by another application or service (e.g., by an embedding solution, by an external service, etc.).

In some instances, the extracted one or more data entries at 412, can be provided to trigger an execution of an application process, e.g., at a communicatively coupled application, such as the application 126 of FIG. 1 or the provider system 106 of FIG. 1. For example, the application 126 can request to execute a search of the structured document that is semantically searchable and process data extracted from the structured document according to implemented logic. In another example, the extracted data can be automatically pushed to the application 126 as soon as the data is extracted and even without a received request from the application 126. Upon triggering the application process, extracted data can be provided to the application and can be automatically output at a graphical user interface on a display device.

The example process 400A for document data extraction provides an advantage of accurately identifying document layouts for data extraction, which enhances the accuracy of the extracted data and facilitates dynamic integration of layout-identification into the data extraction and fine-tuning processes. The described example process 400A supports efficient identification of document layouts that mitigates the computational demands of processing and storing extensive data by relying on generating and evaluating compression ratios.

FIG. 4B is a flowchart of another example process 400B for data extraction based on layout identification, according to some implementations of the present disclosure. Example process 400B can be performed in the context of the server system 102 of FIG. 1. The example process 400B includes a training phase 422 and an inference phase 424.

Within the training phase 422, at 426, an example document with a particular layout is received. The document is received as training data for training a model to extract data from a document of the particular layout. The training can be performed per document layout where one or multiple example documents of a given layout can be used as a training corpus. In some instances, obtaining the example document(s) can include receiving, from a sender (e.g., user device 104 described with reference to FIG. 1) the example document(s) and digitalizing the example document.

At 428, the model is trained, by one or more processors, using the example document(s). A custom extraction model for the specific layout, and the example document(s) can be used to create the reference layout. The model can be trained to determine that if an incoming document matches a reference layout, a corresponding template can be used for the data extraction.

At 430, the model is tested, by the one or more processors, using additional documents (to which a document layout is assigned based on the document layout identification process as described at 440) to determine a layout matching accuracy. The additional documents can include documents with identical or partially similar layouts to determine a layout matching accuracy. The test can generate test results, being indicative of any model training limitations.

At 432, the model is updated, by the one or more processors, based on the test results and optionally, based on feedback obtained from the inference phase 424. For example, in response to determining that the layout matching accuracy is below a set accuracy threshold, additional reference layouts can be generated. In some instances, the additional reference layouts can be created using feedback data indicative of a (corrected) extraction result. In some instances, additional reference layouts can be defined and used to train a process to identify documents of those respective additional reference layouts. For example, based on identifying errors during the extraction, a determination can be made that the layout of the corresponding document is not accurately determined, and a new document layout can be identified which can serve as a reference layout. If an incoming document matches the reference layout, the document and the feedback data can be used to perform few-shot prompting using a machine learning model to automatically adjust the errors, instead of performing manual inspection or applying methods fixing extraction errors without considering the document layout as identified and used during the testing at 430.

At the inference phase 424, at 434 (similar to 404 described with reference to FIG. 4A), a digitalized document is obtained, by the one or more processors (e.g., any component of document data extraction system 110 described with reference to FIG. 1, the document data extraction system architecture 200 described with reference to FIG. 2).

At 436 (similar to 404 described with reference to FIG. 4A), the digitalized document is compressed, by the one or more processors, to generate compressed documents.

At 438 (similar to 406 described with reference to FIG. 4A), compression ratios are generated, by the one or more processors, to determine a layout matching the layout of the obtained digitalized document.

At 440 (similar to 408 described with reference to FIG. 4A), a compression ratio that meets selection criteria for identifying a document layout is identified, by the one or more processors. The identified compression ratio can be assigned to the document.

At 442 (similar to 412 described with reference to FIG. 4A), data entities are extracted from the digitalized document using the identified layout.

At 444, the data entities as extracted can be sent, by the one or more processors, to a user device or another application (e.g., to trigger a process execution, to initiate data storage in a record in a database, among other examples). For example, an application can automatically invoke a process to extract data entities from data fields of the digitalized document. At 446, in response to displaying an outcome of the utilization of the extracted data fields at the sending destination, feedback for the data extraction can be received. The feedback can be transmitted to the training phase 422 to be used to evaluate the training process of the model for the extraction of data, and in some cases, to be used for further updating the model (as described at 432).

FIG. 5 is a block diagram of an example computing system 500 used to provide computational functionalities associated with described algorithms, methods, functions, processes, flows, and procedures, according to some implementations of the present disclosure. As shown in FIG. 5, the computing system 500 can include a processor 510, a memory 520, a storage device 530, and input/output devices 540. The processor 510, the memory 520, the storage device 530, and the input/output devices 540 can be interconnected using a system bus 550. The processor 510 is capable of processing instructions for execution within the computing system 500, such as the example process 400A, 400B described with reference to FIGS. 4A and 4B. Such executed instructions can implement one or more components of, for example, the document data extraction system 110, described with reference to FIG. 1. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided using the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a LAN, a WAN, the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 540. The user interface can be generated and presented to a user by the computing system 500 (e.g., on a computer screen monitor).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) can contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising:
obtaining a digitalized document corresponding to an original document;
compressing, by using a compression algorithm and a plurality of compression dictionaries, the digitalized document to generate a plurality of compressed documents, each of the plurality of compressed documents being generated based on a compression dictionary of the plurality of compression dictionaries, wherein each of the plurality of compression dictionaries is associated with a respective document layout of a plurality of document layouts;
generating, for each of the plurality of compressed documents, a respective compression ratio to provide a plurality of compression ratios for the plurality of compressed documents;
identifying, from the plurality of compression ratios, a matching compression ratio associated with a first compressed document, the matching compression ratio matching a selection criterion to identify a document layout matching the digitalized document;
assigning a first document layout to the digitalized document, wherein the first document layout corresponds to the first compressed document generated based on the respective compression dictionary from the plurality of compression dictionaries; and
extracting, using the assigned first document layout, one or more data entries from the digitalized document to generate a record to be stored at an entity for use in triggering a process at the entity.

Example 2. The method of Example 1, comprising:
generating a structured document based on performing data extraction from the digitalized document according to the assigned first document layout.

Example 3. The computer-implemented method of Examples 1 or 2, wherein compressing the digitalized document comprises applying the compression algorithm to a portion of the digitalized document to generate the plurality of compressed documents, wherein the portion of the digitalized document is predefined to comprise either a number of pages of the digitalized document or a number of words of the digitalized document.

Example 4. The computer-implemented method of any one of the preceding Examples, wherein the respective compression ratio is determined as a fraction of a size of the original document relative to an output size of an output stream resulting from compressing using each of the plurality of compression dictionaries.

Example 5. The computer-implemented method of Example 4, wherein the matching compression ratio is indicative of the first compressed document being with the lowest output size after compressing compared to other compressed documents from the plurality of compressed documents.

Example 6. The computer-implemented method of Example 1, wherein each compression dictionary of the plurality of compression dictionaries is generated from a respective set of example documents comprising a respective document layout.

Example 7. The computer-implemented method of Example 6, wherein the respective set of example documents are used for training a layout identification model to learn characteristics of the plurality of document layouts.

Example 8. The computer-implemented method of Example 7, the method comprising:
executing the layout identification model for a set of documents based on assigning a document layout to each document of the set of documents;
determining a layout matching accuracy of the layout identification model;
in response to determining that the layout matching accuracy is below a set accuracy threshold, defining at least one additional reference layout;
generating at least one additional compression dictionary for the at least one additional reference layouts to be added to the plurality of compression dictionaries to form an updated plurality of compression dictionaries; and
storing the updated plurality of compression dictionaries for use in compressing digitalized documents to determine a respective document layout based on executing the layout identification model, wherein the respective document layout is determined as a document layout from i) the plurality of document layouts or ii) the at least one additional reference layouts.

Example 9. A system comprising:
one or more processors; and
one or more computer-readable memories coupled to the one or more processors and having instructions stored thereon that are executable by the one or more processors to perform the method of any of Examples 1 to 8.

Example 10: A non-transitory, computer-readable medium coupled to one or more processors and having instructions stored thereon which, when executed by the one or more processors, cause the one or more processors to perform the method of any of Examples 1 to 8.

1. A computer-implemented method comprising:
obtaining a digitalized document corresponding to an original document;
compressing, by using a compression algorithm and a plurality of compression dictionaries, the digitalized document to generate a plurality of compressed documents, each of the plurality of compressed documents being generated based on a compression dictionary of the plurality of compression dictionaries, wherein each of the plurality of compression dictionaries is associated with a respective document layout of a plurality of document layouts;
generating, for each of the plurality of compressed documents, a respective compression ratio to provide a plurality of compression ratios for the plurality of compressed documents;
identifying, from the plurality of compression ratios, a matching compression ratio associated with a first compressed document, the matching compression ratio matching a selection criterion to identify a document layout matching the digitalized document;
assigning a first document layout to the digitalized document, wherein the first document layout corresponds to the first compressed document generated based on the respective compression dictionary from the plurality of compression dictionaries; and
extracting, using the assigned first document layout, one or more data entries from the digitalized document to generate a record to be stored at an entity for use in triggering a process at the entity.

2. The method of claim 1, comprising:
generating a structured document based on performing data extraction from the digitalized document according to the assigned first document layout.

3. The computer-implemented method of claim 1, wherein compressing the digitalized document comprises applying the compression algorithm to a portion of the digitalized document to generate the plurality of compressed documents, wherein the portion of the digitalized document is predefined to comprise either a number of pages of the digitalized document or a number of words of the digitalized document.

4. The computer-implemented method of claim 1, wherein the respective compression ratio is determined as a fraction of a size of the original document relative to an output size of an output stream resulting from compressing using each of the plurality of compression dictionaries.

5. The computer-implemented method of claim 4, wherein the matching compression ratio is indicative of the first compressed document being with the lowest output size after compressing compared to other compressed documents from the plurality of compressed documents.

6. The computer-implemented method of claim 1, wherein each compression dictionary of the plurality of compression dictionaries is generated from a respective set of example documents comprising a respective document layout.

7. The computer-implemented method of claim 6, wherein the respective set of example documents are used for training a layout identification model to learn characteristics of the plurality of document layouts.

8. The computer-implemented method of claim 7, the method comprising:
executing the layout identification model for a set of documents based on assigning a document layout to each document of the set of documents;
determining a layout matching accuracy of the layout identification model;
in response to determining that the layout matching accuracy is below a set accuracy threshold, defining at least one additional reference layout;
generating at least one additional compression dictionary for the at least one additional reference layouts to be added to the plurality of compression dictionaries to form an updated plurality of compression dictionaries; and
storing the updated plurality of compression dictionaries for use in compressing digitalized documents to determine a respective document layout based on executing the layout identification model, wherein the respective document layout is determined as a document layout from i) the plurality of document layouts or ii) the at least one additional reference layouts.

9. A non-transitory, computer-readable medium storing one or more instructions executable by a computer system to perform one or more operations, comprising:
obtaining a digitalized document corresponding to an original document;
compressing, by using a compression algorithm and a plurality of compression dictionaries, the digitalized document to generate a plurality of compressed documents, each of the plurality of compressed documents being generated based on a compression dictionary of the plurality of compression dictionaries, wherein each of the plurality of compression dictionaries is associated with a respective document layout of a plurality of document layouts;
generating, for each of the plurality of compressed documents, a respective compression ratio to provide a plurality of compression ratios for the plurality of compressed documents;
identifying, from the plurality of compression ratios, a matching compression ratio associated with a first compressed document, the matching compression ratio matching a selection criterion to identify a document layout matching the digitalized document;
assigning a first document layout to the digitalized document, wherein the first document layout corresponds to the first compressed document generated based on the respective compression dictionary from the plurality of compression dictionaries; and
extracting, using the assigned first document layout, one or more data entries from the digitalized document to generate a record to be stored at an entity for use in triggering a process at the entity.

10. The non-transitory, computer-readable medium of claim 9, wherein the operations further comprise:
generating a structured document based on performing data extraction from the digitalized document according to the assigned first document layout.

11. The non-transitory, computer-readable medium of claim 9, wherein compressing the digitalized document comprises applying the compression algorithm to a portion of the digitalized document to generate the plurality of compressed documents, wherein the portion of the digitalized document is predefined to comprise either a number of pages of the digitalized document or a number of words of the digitalized document.

12. The non-transitory, computer-readable medium of claim 9, wherein the respective compression ratio is determined as a fraction of a size of the original document relative to an output size of an output stream resulting from compressing using each of the plurality of compression dictionaries.

13. The non-transitory, computer-readable medium of claim 9, wherein the matching compression ratio is indicative of the first compressed document being with the lowest output size after compressing compared to other compressed documents from the plurality of compressed documents.

14. The non-transitory, computer-readable medium of claim 9, wherein each compression dictionary of the plurality of compression dictionaries is generated from a respective set of example documents comprising a respective document layout.

15. The non-transitory, computer-readable medium of claim 14, wherein the respective set of example documents are used for training a layout identification model to learn characteristics of the plurality of document layouts.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
obtaining a digitalized document corresponding to an original document;
compressing, by using a compression algorithm and a plurality of compression dictionaries, the digitalized document to generate a plurality of compressed documents, each of the plurality of compressed documents being generated based on a compression dictionary of the plurality of compression dictionaries, wherein each of the plurality of compression dictionaries is associated with a respective document layout of a plurality of document layouts;
generating, for each of the plurality of compressed documents, a respective compression ratio to provide a plurality of compression ratios for the plurality of compressed documents;
identifying, from the plurality of compression ratios, a matching compression ratio associated with a first compressed document, the matching compression ratio matching a selection criterion to identify a document layout matching the digitalized document;
assigning a first document layout to the digitalized document, wherein the first document layout corresponds to the first compressed document generated based on the respective compression dictionary from the plurality of compression dictionaries; and
extracting, using the assigned first document layout, one or more data entries from the digitalized document to generate a record to be stored at an entity for use in triggering a process at the entity.

17. The system of claim 16, wherein the one or more computer memory devices store further instructions that, when executed by the one or more computers, perform further operations comprising:
generating a structured document based on performing data extraction from the digitalized document according to the assigned first document layout.

18. The system of claim 16, wherein compressing the digitalized document comprises applying the compression algorithm to a portion of the digitalized document to generate the plurality of compressed documents, wherein the portion of the digitalized document is predefined to comprise either a number of pages of the digitalized document or a number of words of the digitalized document.

19. The system of claim 16, wherein the respective compression ratio is determined as a fraction of a size of the original document relative to an output size of an output stream resulting from compressing using each of the plurality of compression dictionaries.

20. The system of claim 16, wherein the matching compression ratio is indicative of the first compressed document being with the lowest output size after compressing compared to other compressed documents from the plurality of compressed documents.
